(19) United States
(12) Patent Application Publication
(10) Pub. No.: US 2013/0041512 A1
(43) Pub. Date: Feb. 14, 2013

(54) METHOD FOR THE THERMODYNAMIC ONLINE DIAGNOSIS OF A LARGE INDUSTRIAL PLANT

(71) Applicants: Ulrich Kunze, Bubenreuth (DE); Stefan Raab, Erlangen (DE)

(72) Inventors: Ulrich Kunze, Bubenreuth (DE); Stefan Raab, Erlangen (DE)

(21) Appl. No.: 13/642,863

(22) PCT Filed: Mar. 7, 2011
(86) PCT No.: PCT/EP11/53370

§ 371 Date: Oct. 23, 2012

(30) Foreign Application Priority Data
Apr. 28, 2010 (DE) 102010028315.0

(51) Int. Cl. G06F 1/32

(52) U.S. Cl. 700/286

(57) ABSTRACT

A method for the thermodynamic diagnosis of processes in a large industrial plant, in particular a power plant is provided. The method includes determining a reference state of the large industrial plant, acquiring measured values of a plurality of thermodynamic measured variables in the large industrial plant, determining thermodynamic state variables from the measured values directly following acquisition of the measured values, using a thermodynamic model of the large industrial plant and state equations of an operating medium used in the plant in order to determine an actual state of the plant, wherein the actual state and the reference state are displayed simultaneously in a state diagram near to the time of their determination. A control system for the thermodynamic online diagnosis of a large industrial plant is also provided.

### CROSS REFERENCE TO RELATED APPLICATIONS

This application is the US National Stage of International Application No. PCT/EP2011/053370, filed Mar. 7, 2011 and claims the benefit thereof. The International Application claims the benefits of German application No. 10 2010 028 315.0 DE filed Apr. 28, 2010. All of the applications are incorporated by reference herein in their entirety.

### FIELD OF INVENTION

The invention relates to a method for the thermodynamic online diagnosis of a large industrial plant, in particular a power plant, on the basis of state diagrams. The invention further relates to a control system for the thermodynamic online diagnosis of a large industrial plant.

### BACKGROUND OF INVENTION

Large industrial plants, such as power plants, must make efficient use of the energy invested as a matter of economic survival. One of the most important characteristic variables of efficient energy usage is the efficiency factor. In the case of power plants this means the yield of heat and electrical energy in relation to the energy content of the fuel used.

Losses in the thermodynamic balance which are detrimental to the efficiency of the power plant must therefore be identified as rapidly as possible.

It is common practice at the present time to make use of characteristic variables, such as partial efficiency factors or loss indices, for the thermodynamic diagnosis.

These characteristic variables indicate problems in parts of the plant when an index is determined for the respective part of the plant. The usual procedure is to determine a reference state for said characteristic variables with the aid of a thermodynamic model and to compare said reference state with the current value determined in real time in the plant.

In this case both the reference state and the actual state are determined on the basis of measured values which are acquired at the plant.

A problem with this approach is that the thermodynamic diagnosis is dependent on whether all subprocesses have successfully been taken into account to the greatest possible extent in characteristic variables.

It is also usual to plot state diagrams for the purpose of characterizing thermodynamic processes, in particular cyclic processes. The T-s diagram in particular, which represents the temperature versus the entropy, provides a graphic illustration of the useful energy which can be extracted from a process.

Such representations are only known offline, because an automatic entry in the T-s diagram will fail due to the fact that the entropy cannot always be unequivocally determined from pressure and temperature measurements alone, and additional information required (in particular the steam content of two-phase mixtures) cannot be provided by the measurement techniques usually employed.

### SUMMARY OF INVENTION

The object of the invention is to disclose a method with the aid of which losses can be indicated and evaluated in a clear manner and in a way that is readily understandable to the power plant operator, and the possible causative factors can be identified. At the same time it is intended that the method shall be capable of being automated so that it can be implemented in the process control system of the large industrial plant.

This object is achieved according to the invention by means of the method and the device as claimed in the claims. Advantageous developments of the invention are defined in the dependent claims It is possible, by determining a reference state of a large industrial plant, acquiring measured values of a plurality of thermodynamic measured variables on the large industrial plant, determining thermodynamic state variables from the measured values immediately following acquisition of the measured values using a thermodynamic model of the large industrial plant and state equations of an operating medium used in the plant in order to determine an actual state of the plant, and displaying the actual state and the reference state simultaneously in a state diagram near to the time of their determination, to achieve a very clear and easy means of identifying at which points of the plant losses are occurring, and on what scale.

Advantageously, the thermodynamic state variables are temperature and entropy.

Actual state and reference state are beneficially displayed online.

If the operating medium is water, it is advantageous if the measured variables comprise pressure, temperature, and water content. The measurements should be taken at as many points of the large industrial plant as possible.

Advantageously, the measured variables are measured at points in the large industrial plant at which a phase transition of the operating medium takes place.

The reference state is advantageously determined from a thermodynamic model and characterizing measured variables.

It is beneficial in this case if the characterizing measured variables are ambient conditions and a performance level of the large industrial plant.

The method is particularly advantageous if the large industrial plant is a gas and steam turbine plant.

With regard to the device, the invention relates to a control system for the thermodynamic online diagnosis of a large industrial plant, wherein the software comprises a program component in which modules for thermodynamic model calculations for actual and reference states of the large industrial plant are integrated in such a way that the calculated values are compared online.

The advantage of the method according to the invention in comparison with known methods lies in particular in the fact that the overall process can be visualized and overviewed immediately and without special modeling of subprocesses, and consequently that dependencies between parts of the plant can also be very readily identified.

If no individual characteristic variables are available for certain parts of the plant, the online diagnosis will not be affected thereby, since all parts of the plant will necessarily be mapped by the state diagram.

### BRIEF DESCRIPTION OF THE DRAWINGS

The invention is explained in greater detail by way of example with reference to the schematic drawings, which are not to scale and in which:

FIG. 1 shows a flowchart of the method according to the invention for the thermodynamic online diagnosis, and

FIG. 2 shows a T-s diagram from the online diagnosis.

### DETAILED DESCRIPTION OF INVENTION

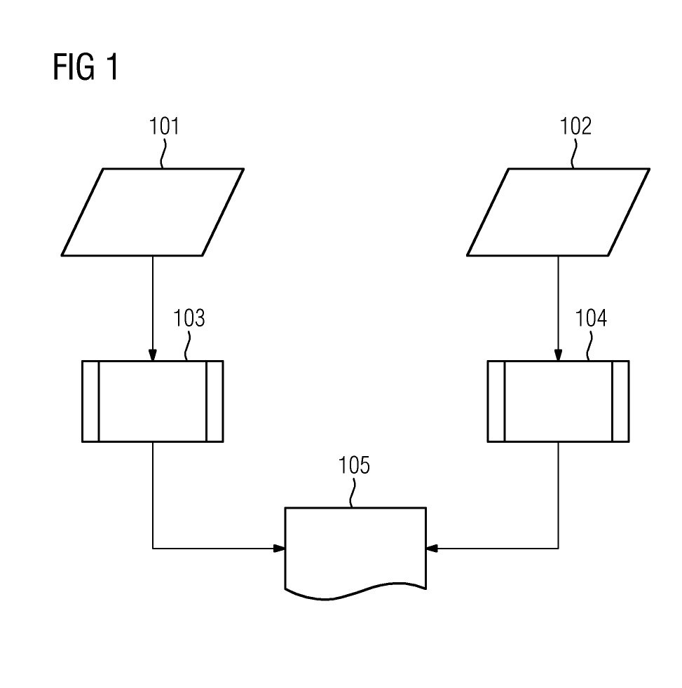

FIG. 1 shows schematically and by way of example a flowchart of the method according to the invention for the thermodynamic online diagnosis. The diagnosis comprises the following steps:

Measured values are acquired from an industrial plant. These relate to a small number of measured variables 101 which characterize the ambient conditions and the performance level of the power plant, and to as much measured data as possible relating to thermodynamic state variables 102 of the plant, such as pressure, temperature, and water content of the operating medium.

Thermodynamic state variables (temperature and entropy) are determined at as many points of the plant as possible using a thermodynamic model for the reference state 103 of the plant, and using the measured variables 101.

In parallel with this, thermodynamic state variables for the actual state 104 are likewise determined from all the obtainable measured variables 102 or, optionally, from a general thermodynamic model (validation calculation in accordance with VDI 2048, consisting of equations for energy and mass balances) of the plant. As result, a consistent set of result values is obtained which describes the actual state 104 in the best possible way. In addition, further calculated variables are obtained which cannot be measured and cannot be calculated in a simple manner (such as e.g. the quality of the low-pressure exhaust steam).

The thermodynamic state variables of both types of origin are represented in the user interface in a state diagram 105.

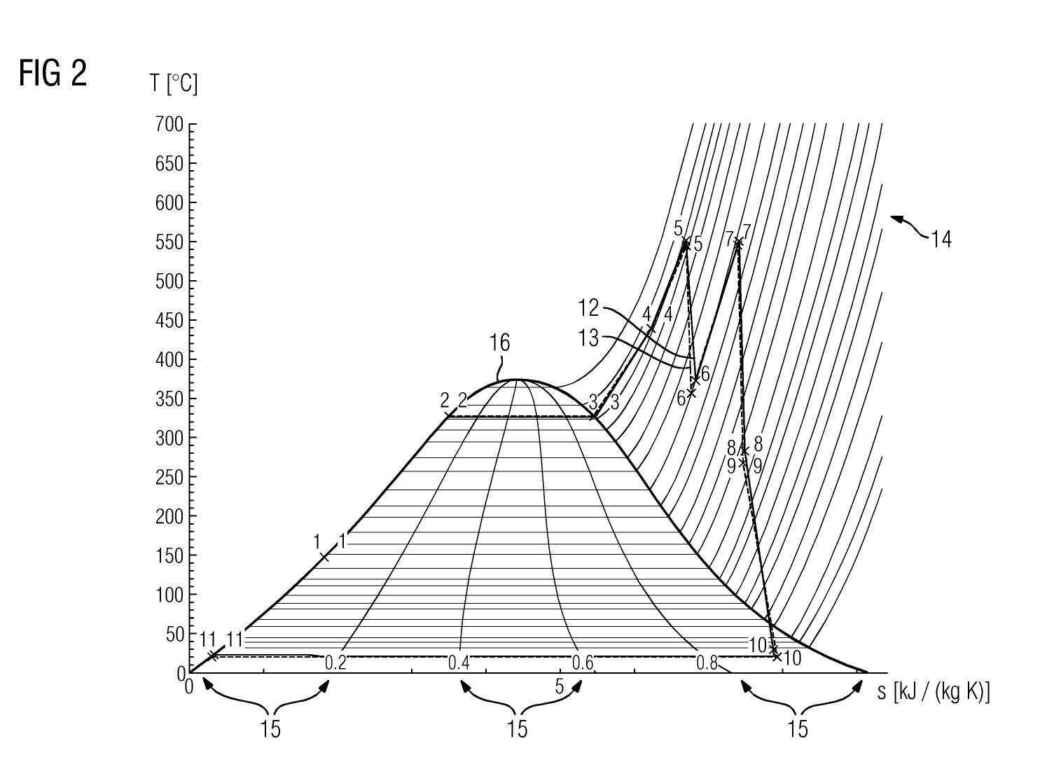

FIG. 2 shows a T-s diagram from the online diagnosis for the water-steam circuit of a gas and steam power plant in order to illustrate the processes. Its abscissa (X-axis) shows the specific entropy s, and its ordinate (Y-axis) shows the temperature T. Entered in the T-s diagram are isobars 14 (lines of equal pressure), lines with the same steam mass fraction 15, and the phase boundary 16.

From this diagram, the efficiency of a Carnot process consisting of two isentropes (lines of equal entropy) and two isotherms (lines of equal temperature), which Carnot process is represented as a rectangle in the T-s diagram, can be read off directly from the surface area ratio. With adiabatic processes, i.e. with thermodynamic processes in which a system is transformed from one state into another without exchanging thermal energy with its surroundings, such as in a steam turbine, for example, the surface area alone represents the dissipated work. If the state transition curve is known through measurement of the state variables (in most cases pressure and temperature), from which, by means of the state equations, the associated entropy can be calculated (as the difference to that of the triple point), the representation in the T-s diagram provides a good overview of the quality of the process.

The isobaric heating of the feedwater to the saturated steam temperature takes place between points 1 and 2 in the T-s diagram. This is followed by the isobaric evaporation between points 2 and 3 in the wet steam region. The steam is superheated up to points 4 and 5. Between points 5 and 6 the superheated steam is expanded in the turbine (high-pressure turbine). Between 6 and 7 the steam is reheated and then expanded further in the turbine (low-pressure turbine) up to point 10. The line between points 10 and 11 describes the condensation of the expanded steam.

In the method according to the invention, actual state 12 and reference state 13 are plotted in the same T-s diagram for the online diagnosis, in a similar manner to that shown in FIG. 2. In other words, the state diagram shows the cyclic process of the plant for the reference state 13 and the actual state 12. Any change in the actual state (e.g. pressure increase, heat input, expansion, heat dissipation) of the cyclic process can thus be compared graphically with a reference state.

For example, a deviation at the expansion endpoint can be observed in FIG. 2 for the state change in the high-pressure steam turbine (from point 5 (live steam) to 6 (cold reheat)). The expansion in the actual state exhibits higher losses in comparison with the reference state.

1-10. (canceled)

11. A method for the thermodynamic diagnosis of a process of a large industrial plant, comprising:
determining a reference state of the large industrial plant, acquiring measured values of a plurality of thermodynamic measured variables on the large industrial plant; and
determining a plurality of thermodynamic state variables from the measured values directly following acquisition of the measured values using a thermodynamic model of the large industrial plant and state equations of an operating medium used in the plant in order to determine an actual state of the plant,
wherein the actual state and the reference state are displayed simultaneously in a state diagram when the actual state and the reference state are determined

12. The method as claimed in claim 11, wherein the plurality of thermodynamic state variables are temperature and entropy.

13. The method as claimed in claim 11, wherein the actual state and the reference state are displayed online.

14. The method as claimed in claim 11, wherein the operating medium is water.

15. The method as claimed in claim 11, wherein the acquired measured variables comprise pressure, temperature, and water content.

16. The method as claimed in claim 11, wherein the measured variables are measured at points in the large industrial plant at which a phase transition of the operating medium takes place.

17. The method as claimed in claim 11, wherein the reference state is determined from a thermodynamic model and a plurality of characterizing measured variables.

18. The method as claimed in claim 17, wherein the plurality of characterizing measured variables are ambient conditions and a performance level of the large industrial plant.

19. The method as claimed in claim 11, wherein the large industrial plant is a gas and steam turbine plant.

20. The method as claimed in claim 11, wherein the large industrial plant is a power plant.

21. A control system for the thermodynamic online diagnosis of a large industrial plant, comprising:
a non-volatile computer-readable medium storing a computer program executed by a data processor, wherein the computer program includes a plurality of modules for thermodynamic model calculations for actual and reference states of the large industrial plant, integrated in such a way that the calculated values are compared online,
wherein ambient conditions and measured variables characterizing the performance level of the large industrial plant are acquired for determining the reference state.
